(19) United States
(12) Patent Application Publication
(10) Pub. No.: US 2026/0269252 A1
(43) Pub. Date: Sep. 10, 2026

(54) POLYMER-COATED-CONDUCTOR ANODE FOR ALL-SOLID-STATE BATTERY

(71) Applicant: Schaeffler Technologies AG & Co. KG, Herzogenaurach (DE)

(72) Inventors: Louis McGrath, Strasburg, OH (US); Yueh-Ting Lai, Akron, OH (US); Kewei Liu, Wadsworth, OH (US)

(21) Appl. No.: 19/069,849

(22) Filed: Mar. 4, 2025

(51) Int. Cl. H01M 4/62; H01M 4/02; H01M 10/0525; H01M 10/0562

(52) U.S. Cl. CPC H01M 4/62; H01M 2004/027; H01M 10/0525; H01M 10/0562; H01M 2300/0065

(57) ABSTRACT

A polymer-coated-conductor anode may include a metal conductor. A polymer-coated-conductor anode may include a polymer layer disposed on a first portion of the metal conductor. A polymer-coated-conductor anode may include an electrically-conductive layer disposed on the polymer layer, where the metal conductor and the electrically-conductive layer are in electrical contact.

### TECHNICAL FIELD

The present disclosure relates generally to solid-state batteries and, more particularly, to solid-state lithium batteries with a polymer-coated-conductor anode.

### BACKGROUND

All-solid-state batteries (ASSBs) with a lithium-free (Li-free) anode or anode-free architecture are promising approaches for providing high energy densities while mitigating safety concerns during production and use. Such architectures may typically utilize a simple current collector as an anode, where the cathode as the primary lithium source. Lithium is plated onto the anode during charging and removed when discharged. The term anode-free or anode-less describes the use of an inactive current collector during the fabrication process and reliance on lithium deposition on the current collector during charging to form an active anode.

Without the need for a pre-deposited lithium layer, the battery can be lighter and more compact, allowing for more active material to be used in the same volume. The absence of lithium metal during cell assembly avoids the need for handling and processing of reactive lithium, which can be challenging and expensive. The relatively simpler structure of ASSBs compared to traditional battery designs may also reduce production costs.

However, existing Li-free or anode-free ASSB architectures can suffer from low initial Coulombic efficiency because the first cycle involves the formation of a solid electrolyte interphase (SEI), which can be unstable and lead to non-uniform lithium deposition, dendrite formation, and/or corrosion. A non-uniform pressure distribution on the anode may also result in non-uniform lithium deposition, especially under relatively low stack pressures. As a result, existing architectures suffer from relatively high resistance and limited cycle life.

There is therefore a need to develop systems and methods addressing the above deficiencies.

### SUMMARY

In embodiments, the techniques described herein relate to a polymer-coated-conductor anode including a metal conductor; a polymer layer disposed on a first portion of the metal conductor; and an electrically-conductive layer disposed on the polymer layer, where the metal conductor and the electrically-conductive layer are in electrical contact.

In embodiments, the techniques described herein relate to a polymer-coated-conductor anode, where the electrically-conductive layer includes a conductive coating.

In embodiments, the techniques described herein relate to a polymer-coated-conductor anode, where the conductive coating includes at least one of a metal or a carbon compound having a thickness in a range of 10 nanometers to 10,000 nanometers.

In embodiments, the techniques described herein relate to a polymer-coated-conductor anode, where the electrically-conductive layer includes a nucleation layer, where the nucleation layer is lithium-active.

In embodiments, the techniques described herein relate to a polymer-coated-conductor anode, where the nucleation layer includes at least one of silver, indium, gold, tin, or aluminum.

In embodiments, the techniques described herein relate to a polymer-coated-conductor anode, where the electrically-conductive layer further includes a conductive coating disposed between the polymer layer and the nucleation layer.

In embodiments, the techniques described herein relate to a polymer-coated-conductor anode, where the metal conductor includes at least one of copper, aluminum, nickel, or stainless steel.

In embodiments, the techniques described herein relate to a polymer-coated-conductor anode, where the polymer layer includes at least one of SBR, PS, polyester, PET, or polycarbonate.

In embodiments, the techniques described herein relate to a polymer-coated-conductor anode, where the polymer layer includes conductive additives.

In embodiments, the techniques described herein relate to a polymer-coated-conductor anode, where the polymer layer has a Young's modulus in a range of 10 MPa to 150 MPa.

In embodiments, the techniques described herein relate to a polymer-coated-conductor anode, where the polymer layer has an elongation at break in a range of 0.01% to 500%.

In embodiments, the techniques described herein relate to a solid-state battery including one or more cells, where a particular cell of the one or more cells includes a polymer-coated-conductor anode including a metal conductor; a polymer layer disposed on a first portion of the metal conductor; and an electrically-conductive layer disposed on the polymer layer, where the metal conductor and the electrically-conductive layer are in electrical contact; a cathode including lithium; and a solid electrolyte between the polymer-coated-conductor anode and the cathode.

In embodiments, the techniques described herein relate to a solid-state battery, where the electrically-conductive layer includes at least one of conductive coating or a nucleation layer.

In embodiments, the techniques described herein relate to a solid-state battery, where the electrically-conductive layer includes at least one of silver, indium, gold, tin, aluminum, or a carbon compound.

In embodiments, the techniques described herein relate to a solid-state battery, where the metal conductor includes at least one of copper, aluminum, nickel, or stainless steel.

In embodiments, the techniques described herein relate to a solid-state battery, where the polymer layer includes at least one of SBR, PS, polyester, PET, or polycarbonate.

In embodiments, the techniques described herein relate to a solid-state battery, where the polymer layer has a Young's modulus in a range of 10 MPa to 150 MPa.

In embodiments, the techniques described herein relate to a solid-state battery, where the polymer layer has an elongation at break in a range of 0.01% to 500%.

In embodiments, the techniques described herein relate to a method for fabricating a polymer-coated-conductor anode including depositing a polymer layer on a metal conductor; and depositing an electrically-conductive layer on the polymer layer, where the metal conductor and the electrically-conductive layer are in electrical contact.

In embodiments, the techniques described herein relate to a method for fabricating a polymer-coated-conductor anode, where depositing the electrically-conductive layer on the polymer layer includes depositing the electrically-conductive layer on the metal conductor with at least one of a physical vapor deposition process, a spray coating process, an electroplating process, or an electroless plating process.

It is to be understood that both the foregoing general description and the following detailed description are exemplary and explanatory only and are not necessarily restrictive of the invention as claimed. The accompanying drawings, which are incorporated in and constitute a part of the specification, illustrate embodiments of the invention and together with the general description, serve to explain the principles of the invention.

### BRIEF DESCRIPTION OF DRAWINGS

The numerous advantages of the disclosure may be better understood by those skilled in the art by reference to the accompanying figures.

FIG. 1 illustrates a block diagram of an all-solid-state battery (ASSB), in accordance with one or more embodiments of the present disclosure.

FIG. 2A illustrates a simplified side view of one non-limiting design of a polymer-coated-conductor anode, in accordance with one or more embodiments of the present disclosure.

FIG. 2B illustrates a simplified side view of one non-limiting design of a polymer-coated-conductor anode, in accordance with one or more embodiments of the present disclosure.

FIG. 2C illustrates a simplified side view of one non-limiting design of a polymer-coated-conductor anode, in accordance with one or more embodiments of the present disclosure.

FIG. 2D illustrates a simplified side view of one non-limiting design of a polymer-coated-conductor anode, in accordance with one or more embodiments of the present disclosure.

FIG. 2E illustrates a simplified side view of one non-limiting design of a polymer-coated-conductor anode, in accordance with one or more embodiments of the present disclosure.

FIG. 3 illustrates a simplified side view of an ASSB with three stacked cells, in accordance with one or more embodiments of the present disclosure.

FIG. 4 illustrates a plot depicting the cycling performance of an ASSB with a polymer-coated-conductor anode relative to a bare copper anode, in accordance with one or more embodiments of the present disclosure.

FIG. 5 illustrates a flow diagram illustrating steps performed in a method 500 for fabricating a polymer-coated-conductor anode 104, in accordance with one or more embodiments of the present disclosure.

### DETAILED DESCRIPTION

Reference will now be made in detail to the subject matter disclosed, which is illustrated in the accompanying drawings. The present disclosure has been particularly shown and described with respect to certain embodiments and specific features thereof. The embodiments set forth herein are taken to be illustrative rather than limiting. It should be readily apparent to those of ordinary skill in the art that various changes and modifications in form and detail may be made without departing from the spirit and scope of the disclosure.

Embodiments of the present disclosure are directed to systems and methods providing an all-solid-state battery (ASSB) including a polymer-coated-conductor anode formed as a metal conductor having at least a polymer layer and an electrically-conductive layer. Such a configuration may be suitable for, but not limited to, lithium-free (Li-free) or anode-free ASSB architectures and may facilitate even deposition of lithium during charging while mitigating corrosion and capacity degradation.

A manufactured ASSB is typically constructed from rigid components (e.g., anode, cathode, solid electrolyte, or the like) that are held in contact (e.g., with some pressure). In this design, various conditions may give rise to a potential non-uniform pressure distribution across the anode (or other components) such as, but not limited to, roughness of a solid electrolyte or non-uniform thicknesses of various cell components. However, such a non-uniform pressure distribution may negatively impact the performance of the anode (or other components). For example, in Li-free or anode-free architectures, a non-uniform pressure distribution across the anode may result in a non-uniform deposition of lithium across the anode, which may increase resistivity, induce corrosion, and/or consume lithium and thus degrade cell capacity.

In embodiments, a polymer-coated-conductor anode is formed as a metal conductor that may operate as a current collector, where the metal conductor is covered with a polymer layer and an electrically-conductive layer, where the electrically-conductive layer is in electrical contact with the metal conductor. In some embodiments, the electrically-conductive layer is or includes a nucleation layer may include a lithium-active material that may promote lithium deposition on the anode. The polymer layer may promote a uniform pressure distribution across the anode in a packaged ASSB, which may in turn promote uniform lithium deposition across the anode during charging cycles.

It is contemplated that the uniform pressure and associated lithium deposition uniformity provided by a polymer-coated-conductor anode as disclosed herein may provide stable cycling performance and mitigate potential corrosion of the underling metal conductor.

Some embodiments of the present disclosure are directed to a polymer-coated-conductor anode suitable for use in an ASSB or a cell thereof. Some embodiments of the present disclosure are directed to an ASSB battery cell (or a solid-state battery cell) including a polymer-coated-conductor anode. Some embodiments of the present disclosure are directed to an ASSB including one or more cells with a polymer-coated-conductor anode. Some embodiments of the present disclosure are directed to a method of fabricating a polymer-coated-conductor anode suitable for use in an ASSB or a cell thereof.

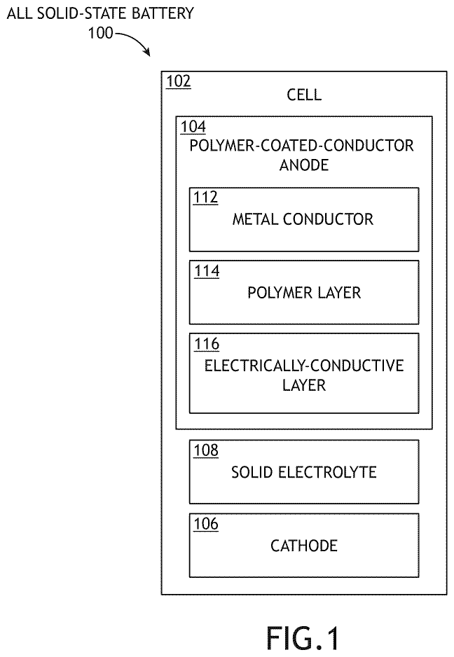

Referring now to FIGS. 1-5, systems and methods providing a layered anode suitable for an ASSB, in accordance with one or more embodiments of the present disclosure.

FIG. 1 illustrates a block diagram of an ASSB 100, in accordance with one or more embodiments of the present disclosure.

In embodiments, the ASSB 100 includes one or more cells 102, where a cell 102 includes at least a polymer-coated-conductor anode 104, a cathode 106, and a solid electrolyte 108 between the polymer-coated-conductor anode 104 and the cathode 106. In some embodiments, a cell 102 additionally includes a cathode current collector 110.

In embodiments, the polymer-coated-conductor anode 104 is formed as a metal conductor 112 with a polymer layer 114 and an electrically-conductive layer 116 that is in electrical contact with the metal conductor 112. For example, the polymer layer 114 may be disposed on the metal conductor 112 and the electrically-conductive layer 116 may be disposed on the polymer layer 114. Further, the electrically-conductive layer 116 may contact the metal conductor 112 at one or more contact points. For example, the electrically-conductive layer 116 may extend down sides of at least the polymer layer 114 (and in some cases the metal conductor 112) to contact the metal conductor 112. In some embodiments, as is described in greater detail throughout the present disclosure, the electrically-conductive layer 116 is a multilayer structure formed from multiple materials.

The metal conductor 112 may include any metal or metal alloy suitable for operation as a current collector in a cell 102 of an ASSB 100. For example, the metal conductor 112 may include, but is not limited to, copper, aluminum, nickel, or stainless steel.

The polymer layer 114 may include any composition suitable for uniformizing a pressure distribution across the polymer-coated-conductor anode 104 when the cell 102 is held under pressure. Non-limiting examples of the polymer layer 114 include styrene-butadiene rubber (SBR), polystyrene (PS), polyester, polycarbonate, or polyethylene terephthalate (PET). It is contemplated herein that the quality and uniformity of lithium deposition in an anode-free or Li-free ASSB 100 during cycling may be influenced by the uniformity of the pressure distribution across the anode. Accordingly, the polymer layer 114 may provide mechanical uniformization of the pressure distribution across the polymer-coated-conductor anode 104 and may thus promote uniform lithium deposition, stable cycling, and mitigate corrosion.

It is contemplated herein that the polymer layer 114 need not create a perfectly uniform pressure distribution. In some applications, the polymer layer 114 facilitates a pressure distribution across the polymer-coated-conductor anode 104 that is uniform within a selected tolerance. Any selected tolerance may be chosen based on the application. For example, the tolerance may be a pressure variation (e.g., an average pressure variation, a maximum pressure variation, or the like) at or below a selected percentage (e.g., 0.1%, 1%, 5%, 10%, or any selected value).

It is further contemplated herein that the ability of a polymer layer 114 to uniformize a pressure distribution may depend on mechanical properties related to rigidity. In a general sense, reducing a rigidity of the polymer layer 114 may improve the performance so long as the polymer layer 114 is sufficiently rigid to remain in place. In some embodiments, the polymer layer 114 has a Young's Modulus in a range of 10 MPa to 150 GPa. In some embodiments, the polymer layer 114 has an elongation at break value in a range of 0.01% to 500%. For example, the elongation at break value may characterize a percentage increase in length the polymer layer 114 can withstand before breaking.

The polymer layer 114 may have any thickness suitable for providing a desired pressure distribution across the polymer-coated-conductor anode 104. For example, the polymer layer 114 may have a thickness in a range of 0.01 micrometers to 100 micrometers.

The electrically-conductive layer 116 may include any material or combination of materials providing electrical conductivity sufficient for operating as a current collector in the ASSB 100. In some embodiments, the electrically-conductive layer 116 has a conductivity in a range of 1×10² S/m to 7×10⁷ S/m, though this is not a requirement.

In some embodiments, the electrically-conductive layer 116 includes a conductive coating formed from a metal or a carbon compound (e.g., a carbonaceous material). For example, a conductive coating may include, but is not limited to, graphite, graphene, carbon nanotubes, metal fiber, metal mesh, or the like. A conductive coating may have any suitable thickness including, but not limited to, 1 nanometer to 10,000 nanometers. It is contemplated herein that an electrically-conductive layer 116 that includes a conductive coating may be suitable for, but not limited to, configurations of an ASSB 100 that include an active anode material (e.g., a carbon compound, silicon, or the like).

In some embodiments, the electrically-conductive layer 116 includes a nucleation layer that is lithium-active. As used herein, the term lithium-active refers to a composition on which lithium may be intercalated, alloyed, and/or undergo a conversion reaction. For example, the nucleation layer may include, but is not limited to, silver, indium, gold, tin, aluminum, or lithium. The nucleation layer 116 may have any suitable thickness. For example, the nucleation layer 116 may have a thickness in a range of 1 nanometer to 10,000 nanometers. It is contemplated herein that an electrically-conductive layer 116 that includes a nucleation layer be suitable for, but not limited to, configurations of an ASSB 100 that do not include an active anode material (e.g., li-free or lithium metal configuration). In particular, the nucleation layer 116 may promote uniform deposition of lithium on the polymer-coated-conductor anode 104 during cycling.

An electrically-conductive layer 116 including a nucleation layer may provide an artificial solid-electrolyte interface (SEI) that may facilitate deposition of lithium on the polymer-coated-conductor anode 104 while avoiding or at least mitigating lithium consumption and corrosion of the metal conductor 112. As a result, the polymer-coated-conductor anode 104 may provide stable cycling behavior without capacity degradation.

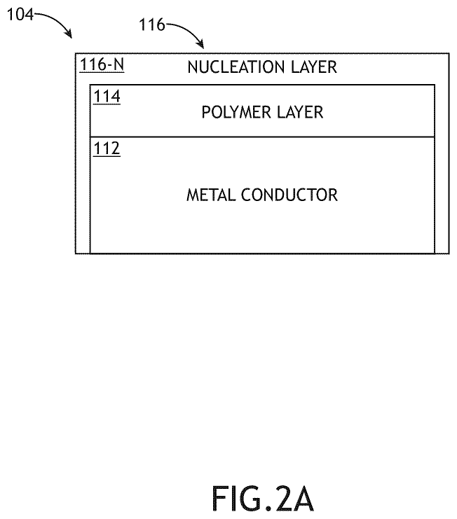

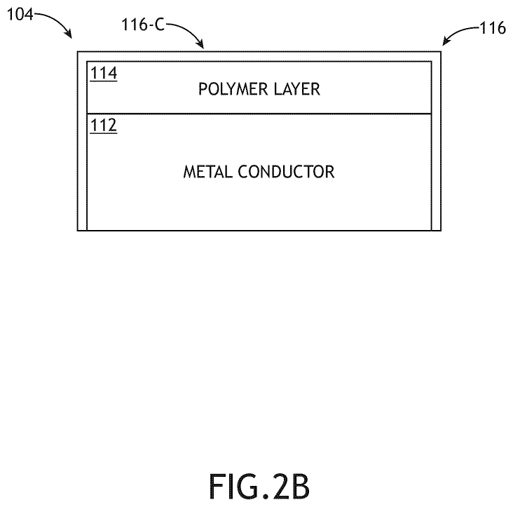

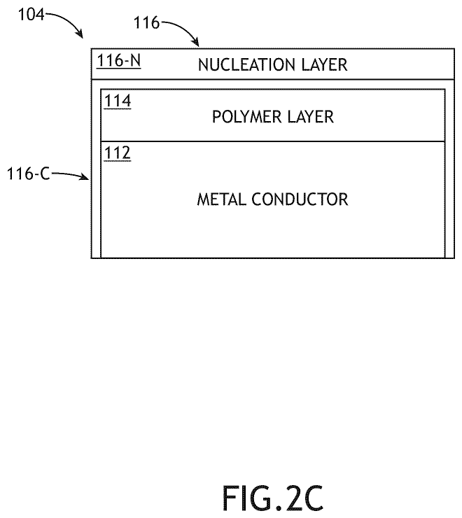

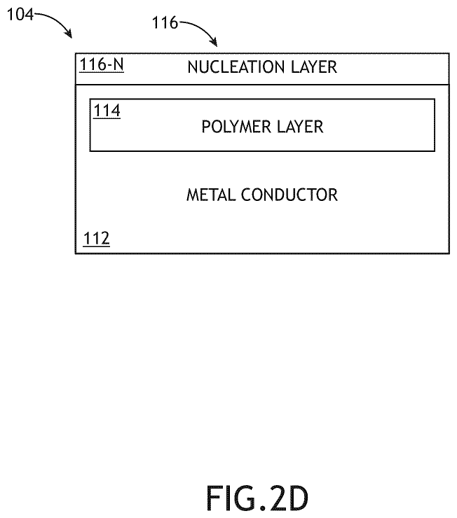

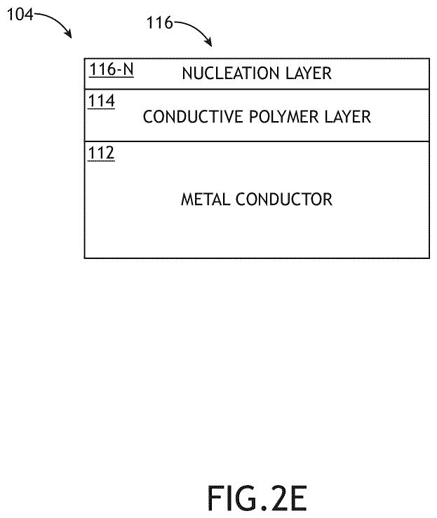

Referring now to FIGS. 2A-2E, various non-limiting designs of the polymer-coated-conductor anode 104 are described in greater detail, in accordance with one or more embodiments of the present disclosure.

In some embodiments, the polymer layer 114 is electrically insulating (e.g., electrically non-conductive). In this configuration, electrical contact may be provided between the metal conductor 112 and the electrically-conductive layer 116 using any suitable technique including, but not limited to, depositing the electrically-conductive layer 116 down sides of the polymer layer 114 to contact the metal conductor 112 or depositing an additional conductive material to contact both the electrically-conductive layer 116 and the metal conductor 112.

FIG. 2A illustrates a simplified side view of one non-limiting design of a polymer-coated-conductor anode 104, in accordance with one or more embodiments of the present disclosure. In particular, FIG. 2A depicts a configuration in which a polymer layer 114 is disposed on the metal conductor 112 and an electrically-conductive layer 116 is disposed on the polymer layer 114, where the electrically-conductive layer 116 is formed as a nucleation layer 116-N. In this way, the nucleation layer 116-N may be lithium-active and may promote even deposition of lithium on the polymer-coated-conductor anode 104 during charging as well as mitigate corrosive lithium consumption. Accordingly, the polymer-coated-conductor anode 104 in FIG. 2A may be suitable for use in a Li-free or anode-free ASSB 100 architectures. Further, the nucleation layer 116-N is shown in FIG. 2A as extending down the sides of the polymer layer 114 and the metal conductor 112 to provide electrical contact with the metal conductor 112.

FIG. 2B illustrates a simplified side view of one non-limiting design of a polymer-coated-conductor anode 104, in accordance with one or more embodiments of the present disclosure. FIG. 2B is similar to FIG. 2A, except that the electrically-conductive layer 116 is depicted as a conductive coating 116-C. In FIG. 2B, the conductive coating 116-C also extends down the sides of the polymer layer 114 and the metal conductor 112 to provide contact with the metal conductor 112.

FIG. 2C illustrates a simplified side view of one non-limiting design of a polymer-coated-conductor anode 104, in accordance with one or more embodiments of the present disclosure. In FIG. 2C, the polymer-coated-conductor anode 104 includes an electrically-conductive layer 116 formed as a conductive coating 116-C disposed on the polymer layer 114 and a nucleation layer 116-N disposed on the conductive coating 116-C. It is contemplated herein that that the conductivity of the nucleation layer 116-N may degrade over time and/or repeated cycling. Accordingly, the design depicted in FIG. 2C that further includes the conductive coating 116-C may ensure electrical contact with the metal conductor 112.

FIG. 2D illustrates a simplified side view of one non-limiting design of a polymer-coated-conductor anode 104, in accordance with one or more embodiments of the present disclosure. FIG. 2D is similar to FIG. 2C, except that the conductive coating 116-C has the same composition as the metal conductor 112 such that this composition at least partially surrounds the metal conductor 112.

In some embodiments, the polymer layer 114 is electrically-conductive. For example, the polymer layer 114 may include conductive such as, but not limited to, metal particles or carbon compounds. Further, the polymer layer 114 may include any concentration of conductive additives to provide that the polymer layer 114 has any selected electrical conductivity value. For example, the polymer layer 114 may have a conductivity in a range of 1×10² S/m to 7×10⁷ S/m, though this is not a requirement.

FIG. 2E illustrates a simplified side view of one non-limiting design of a polymer-coated-conductor anode 104, in accordance with one or more embodiments of the present disclosure. In FIG. 2E, the polymer layer 114 includes a composite polymer with conductive additives such that the electrically-conductive layer 116 may be in electrical contact with the metal conductor 112 through the polymer layer 114. In this configuration, the electrically-conductive layer 116 and the metal conductor 112 do not need to be in direct contact as depicted in FIGS. 2A-2D.

The integration of a polymer-coated-conductor anode 104 into an ASSB 100 is described in greater detail. In embodiments, an ASSB 100 includes one or more cells 102, which may be arranged into any formation including a stacked formation.

A cell 102 of an ASSB 100 may include any type or composition of cathode 106 and solid electrolyte 108 suitable for operation as a battery. In this way, a polymer-coated-conductor anode 104 may be utilized in any desired chemistry of an ASSB 100.

The cathode 106 may have any composition incorporating lithium that may propagate through the cell 102 during operation. For example, the cathode 106 may include a lithium nickel cobalt aluminum (Li-NCA) oxide. As another example, a cathode 106 may include lithium nickel manganese cobalt (Li-NMC) oxide. As another example, the cathode 106 may include manganese oxide in any suitable form including, but not limited to Li₂Mn₂O₄, LiMnO₂, Li₂MnO₂, or a composite thereof. As another example, a cathode 106 may include lithium iron phosphate (LFP), where the active material may include, but is not limited to, LiFePO₄. As another example, the cathode 106 may include sulfur or lithium sulfide.

The solid electrolyte 108 may have any composition known in the art including, but not limited to, oxide electrolytes, sulfide electrolytes, polymer electrolytes, halide electrolytes, composite electrolytes, or hybrid solid-liquid electrolytes. For example, the solid electrolyte 108 may include lithium phosphorus oxynitride (LiPON). As another example, the solid electrolyte 108 may include sodium super-ionic conductors (NASICON) such as, but not limited to, LTP, LATP, or LAGP). As another example, the solid electrolyte 108 may include lithium super-ionic conductors (LISICON) such as, but not limited to, LGPS, LiPS, or LiSiPS. As another example, the solid electrolyte 108 may include garnets such as, but not limited to, LLZO. Various other non-limiting examples include LiBH₄, LYC, LYB, Li₃N, or LLTO.

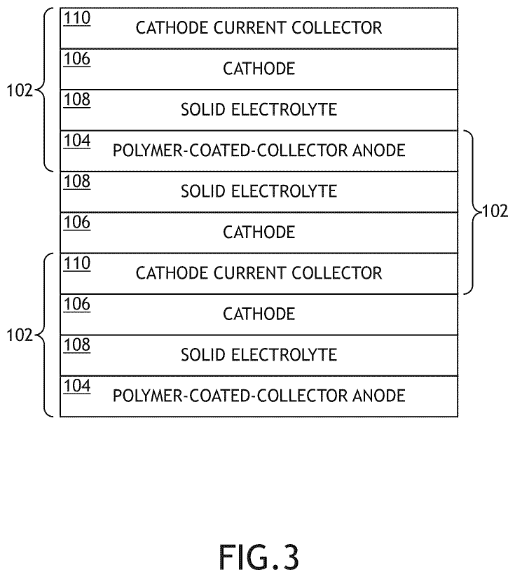

In some embodiments, an ASSB 100 includes multiple cells 102 in a stacked configuration. FIG. 3 illustrates a simplified side view of an ASSB 100 with three stacked cells 102, in accordance with one or more embodiments of the present disclosure. In FIG. 3, each cell 102 includes a polymer-coated-conductor anode 104, a solid electrolyte 108, a cathode 106, and a cathode current collector 110 coupled with the cathode 106. In this stack design, a cathode current collector 110 as well as the polymer-coated-conductor anode 104 may be shared between adjacent cells 102. It is noted that when the polymer-coated-conductor anode 104 is shared between cells 102, the polymer layer 114 and the electrically-conductive layer 116 may be present on both sides of the metal conductor 112 and thus be present in each cell 102.

It is to be understood, however, that FIG. 3 and the associated description is provided solely for illustrative purposes and should not be interpreted as limiting the scope of the present disclosure. For example, an ASSB 100 may include any number of cells 102. As another example, cells 102 may be stacked in any type of configuration including, but not limited to, a bipolar stack configuration.

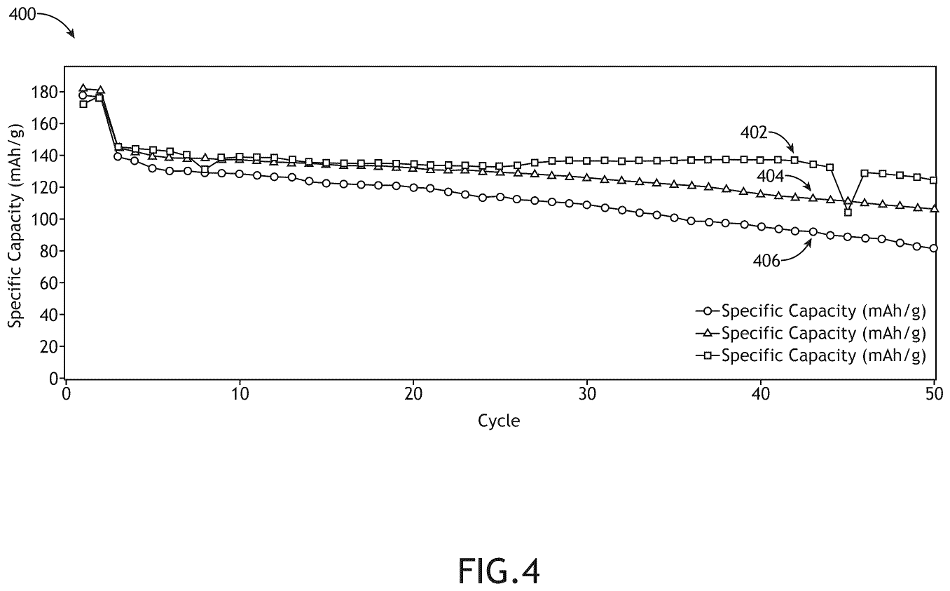

FIG. 4 illustrates a plot 400 depicting the cycling performance of an ASSB 100 with a polymer-coated-conductor anode 104 relative to a bare copper anode, in accordance with one or more embodiments of the present disclosure. In FIG. 4, an ASSB 100 with different configurations of an anode are cycled at a C/1 rate. In particular, FIG. 4 depicts a first dataset 402 with a polymer-coated-conductor anode 104 formed as depicted in FIG. 2C with an electrically-conductive layer 116 with a nucleation layer including silver, a conductive coating 116-C including copper, a polymer layer 114 including SBR, and a copper metal conductor 112. FIG. 4 further depicts a second dataset 404 with a polymer-coated-conductor anode 104 formed with a polymer layer 114 but no electrically-conductive layer 116. FIG. 4 further depicts a third dataset associated with a bare copper anode for reference. In all cases, the pressure used to hold the cell 102 together was 5 MPa.

As depicted in FIG. 4, both the first dataset 402 and the second dataset 404 associated with a polymer-coated-conductor anode 104 as disclosed herein provide stable cycling performance with relatively little degradation of capacity. However, the third dataset 406 associated with a traditional bare copper anode exhibited substantial degradation of cycling performance and capacity.

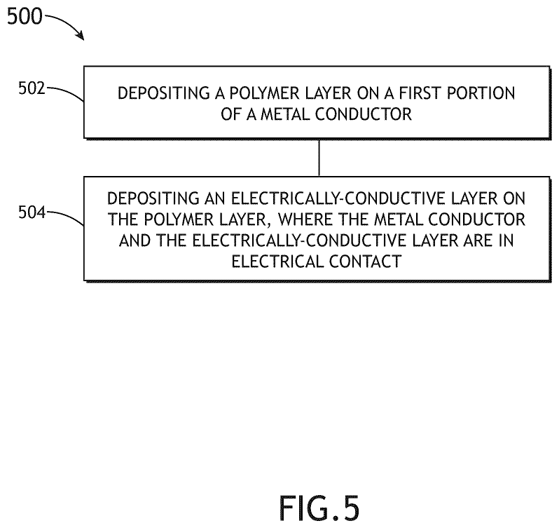

Referring now to FIG. 5, FIG. 5 illustrates a flow diagram illustrating steps performed in a method 500 for fabricating a polymer-coated-conductor anode 104, in accordance with one or more embodiments of the present disclosure. The embodiments and enabling technologies described previously herein in the context of the ASSB 100 should be interpreted to extend to method 500. It is further noted, however, that the method 500 is not limited to the architecture of ASSB 100.

The method 500 may include a step 502 of depositing a polymer layer 114 on a metal conductor 112. The method 500 may include a step 504 of depositing an electrically-conductive layer 116 on the polymer layer 114, where the electrically-conductive layer 116 is lithium-active, wherein the metal conductor 112 and the electrically-conductive layer 116 are in electrical contact.

As described with respect to FIGS. 2A-2E, the polymer layer 114 may include any composition and thickness suitable for uniformizing contact (e.g., within a selected tolerance) between the polymer-coated-conductor anode 104 and the solid electrolyte 108 to promote even current distribution, stable performance, and avoid degradation. For example, the tolerance may be a pressure variation (e.g., an average pressure variation, a maximum pressure variation, or the like) at or below a selected percentage (e.g., 0.1%, 1%, 5%, 10%, or any selected value).

The polymer-coated-conductor anode 104 may include an electrically-conductive layer 116 of any type including, but not limited to, a conductive coating and/or a nucleation layer. Additionally, electrical contact between the metal conductor 112 and the electrically-conductive layer 116 may be provided through any suitable design of the polymer-coated-conductor anode 104. In some embodiments, a portion of the electrically-conductive layer 116 (e.g., a conductive coating, a nucleation layer, or the like) extends along sides of the polymer layer 114 to contact the metal conductor 112. In some embodiments, the polymer layer 114 is electrically conductive (e.g., due to the presence of conductive additives) such that electrical contact is provided through the polymer layer 114.

Further, the deposition steps (e.g., step 502 and step 504) may be performed using any deposition technique including, but not limited to, a physical vapor deposition process, a spray coating process, an electroplating process, or an electroless plating process.

The herein described subject matter sometimes illustrates different components contained within, or connected with, other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “connected” or “coupled” to each other to achieve the desired functionality, and any two components capable of being so associated can also be viewed as being “couplable” to each other to achieve the desired functionality. Specific examples of couplable include but are not limited to physically interactable and/or physically interacting components and/or wirelessly interactable and/or wirelessly interacting components and/or logically interactable and/or logically interacting components.

It is believed that the present disclosure and many of its attendant advantages will be understood by the foregoing description, and it will be apparent that various changes may be made in the form, construction, and arrangement of the components without departing from the disclosed subject matter or without sacrificing all of its material advantages. The form described is merely explanatory, and it is the intention of the following claims to encompass and include such changes. Furthermore, it is to be understood that the invention is defined by the appended claims.

### LIST OF REFERENCE NUMBERS

100 all-solid-state battery (ASSB)
102 cell
104 polymer-coated-conductor anode
106 cathode
108 solid electrolyte
110 cathode current collector
112 metal conductor
114 polymer layer
116 electrically-conductive layer
116-N nucleation layer
116-C conductive coating
400 plot
402 first dataset
404 second dataset
406 third dataset
500 method
502 step
504 step

What is claimed:

1. A polymer-coated-conductor anode comprising:
a metal conductor;
a polymer layer disposed on a first portion of the metal conductor; and
an electrically-conductive layer disposed on the polymer layer, wherein the metal conductor and the electrically-conductive layer are in electrical contact.

2. The polymer-coated-conductor anode of claim 1, wherein the electrically-conductive layer comprises:
a conductive coating.

3. The polymer-coated-conductor anode of claim 2, wherein the conductive coating comprises:
at least one of a metal or a carbon compound having a thickness in a range of 1 nanometer to 10,000 nanometers.

4. The polymer-coated-conductor anode of claim 1, wherein the electrically-conductive layer comprises:
a nucleation layer, wherein the nucleation layer is lithium-active.

5. The polymer-coated-conductor anode of claim 4, wherein the nucleation layer comprises:
at least one of silver, indium, gold, tin, aluminum, or lithium.

6. The polymer-coated-conductor anode of claim 4, wherein the electrically-conductive layer further comprises:
a conductive coating disposed between the polymer layer and the nucleation layer.

7. The polymer-coated-conductor anode of claim 1, wherein the metal conductor comprises at least one of copper, aluminum, nickel, or stainless steel.

8. The polymer-coated-conductor anode of claim 1, wherein the polymer layer comprises:
at least one of SBR, PS, polyester, PET, or polycarbonate.

9. The polymer-coated-conductor anode of claim 1, wherein the polymer layer includes conductive additives.

10. The polymer-coated-conductor anode of claim 1, wherein the polymer layer has a Young's modulus in a range of 10 MPa to 150 MPa.

11. The polymer-coated-conductor anode of claim 1, wherein the polymer layer has an elongation at break in a range of 0.01% to 500%.

12. A solid-state battery comprising:
one or more cells, wherein a particular cell of the one or more cells comprises:
a polymer-coated-conductor anode comprising:
a metal conductor;
a polymer layer disposed on a first portion of the metal conductor; and
an electrically-conductive layer disposed on the polymer layer, wherein the metal conductor and the electrically-conductive layer are in electrical contact;
a cathode including lithium; and
a solid electrolyte between the polymer-coated-conductor anode and the cathode.

13. The solid-state battery of claim 12, wherein the electrically-conductive layer comprises:
at least one of conductive coating or a nucleation layer.

14. The solid-state battery of claim 12, wherein the electrically-conductive layer comprises:
at least one of silver, indium, gold, tin, aluminum, lithium, or a carbon compound.

15. The solid-state battery of claim 12, wherein the metal conductor comprises at least one of copper, aluminum, nickel, or stainless steel.

16. The solid-state battery of claim 12, wherein the polymer layer comprises:
at least one of SBR, PS, polyester, PET, or polycarbonate.

17. The solid-state battery of claim 12, wherein the polymer layer has a Young's modulus in a range of 10 MPa to 150 MPa.

18. The solid-state battery of claim 12, wherein the polymer layer has an elongation at break in a range of 0.01% to 500%.

19. A method for fabricating a polymer-coated-conductor anode comprising:
depositing a polymer layer on a metal conductor; and
depositing an electrically-conductive layer on the polymer layer, wherein the metal conductor and the electrically-conductive layer are in electrical contact.

20. The method for fabricating a polymer-coated-conductor anode of claim 19, wherein depositing the electrically-conductive layer on the polymer layer comprises depositing the electrically-conductive layer on the metal conductor with at least one of a physical vapor deposition process, a spray coating process, an electroplating process, or an electroless plating process.
